(19) United States
(12) Patent Application Publication
(10) Pub. No.: US 2002/0124186 A1
(43) Pub. Date: Sep. 5, 2002

(54) Network security system

(76) Inventors: Eriko Goto, Koganei-shi (JP); Yasuhiro Oshima, Shiosiri-shi (JP); Yasuo Shibusawa, Matsumoto-shi (JP)

Correspondence Address: HOGAN & HARTSON L.L.P., 500 S. GRAND AVENUE, SUITE 1900, LOS ANGELES, CA, 90071-2611, US

(21) Appl. No.: 09/821,729

(22) Filed: Mar. 28, 2001

(30) Foreign Application Priority Data
Mar. 29, 2000 (JP) 2000-092496

(51) Int. Cl. G06F 12/14

(52) U.S. Cl. 713/201

(57) ABSTRACT

ordering information is received by the server 3 through the network 1, when the order is placed by a user. The received data storage means 6 stores data with an external format 4 the server received. The received data format conversion means 7 converts data with an external format 4 stored in the received data storage means 6 to data with an internal format 5, and must be stored in the received process data storage means 8. The host computer 10 administrates the orders using the data with the internal format 5 stored in the received process data storage means.

By the construction stated above, fraudulent data can be eliminated as the received data format conversion means 7 can convert data with an external format 4 to data with reliable internal format 5.

### BACKGROUND TECHNOLOGY

In a system such as one for the sale of goods in use in such networks as the Internet, sales administration such as one which arranges goods and delivers it are conducted by obtaining order information through the network and writing the information to a database. In such a system, in case the order information is damaged through the acquisition of fraudulent data from the network, order obtaining activity is suspended, and extreme damage may occur. Also in the case where customer information is stolen through the network by a fraudulent means, significant credit problems occur. Therefore, a security system, known as a firewall, is placed between the network and the internal system to prevent the invasion of hackers and the like.

In the prior art of technology described above, the following problems must be overcome.

A firewall requires identification information and security code and the like and authentication to ensure the right to access for those about to access the Internal system through the network.(Patent publications 11-298639, and 10-214304). However, it is not easy to protect against hackers who obtain identification information and security code by fraudulent means and camouflage. Moreover, in the ways to obtain the order information from general run of users and take them into the database such as the system of order and sales of goods, a system is necessary to assure the elimination of fraudulent data about to become mixed with the order information. Also, a system is necessary to assuredly eliminate actions for fraudulently reading the contents of the database.

### DESCRIPTION OF THE INVENTION

The present invention adopts the following constructions to resolve the problems stated above.

### Construction 1

A network security system comprising a server connected to a net work, a received data storage means to store data with an external format which a server received through the new work, a received data format conversion means to convert data with an external format stored in the received data storage means to data with the internal format and to store them in a received-process data storage means and a host computer to execute a predetermined process utilizing data with internal format stored in the received-process data storage means.

A server is connected to the network. Data with an external format is received from other terminal units through the network. The data format of data with the external format is optional. The data format of data with the internal format is optional as well.

The received data formal conversion means reads out data with the external format from the received data storage means and converts them to data with the internal format in a fixed procedure, and afterwards, writes them in the received process data storage means. Data with the internal format stored in the received process data storage means are utilized by the host computer. The received data format conversion means extracts and fabricates only necessary data from the data with an external format, and converts them to internal data with the predetermined and reliable format.

Data with an external format received through the network is written in the received data storage means, but the host computer does not directly access to the received data storage means. This is why obtaining in fraudulent data can be prevented. Namely, when the received data format conversion means converts data with an external format to data with an internal format, it can convert the data with the external format to internal data with a reliable format, thereby eliminating the fraudulent data. The host computer can access the received process data storage means with selective timing and use the data with the internal format.

### Construction 2

A network security system according to construction 1, wherein the received data storage means allows data with an external format which the server received to be written, and prevents data from being read out by the server, a received process data storage means allows data with an internal format to be read out by the host computer and prevents data from being written by the host computer.

The reason the received data storage means prevents data from being read out by the server is to prevent the data in the received data storage means from being read out from the network side. The reason writing data into the received process data means by the host computer is prevented is to prevent data from being carelessly output from the host computer side to the network side. This prevents the flow of data from the host computer to the network, and data on the host computer side is not read out to the network side., All data are prevented from being written or read out. This includes all formats of data, whether internal or external.

### Construction 3

A network security system according to construction 1 or 2, wherein the received data storage means allows data with an external format to be read out by the received data format conversion means and prevents data from being written by the received data format conversion means, and the received process data storage means allows data with an internal format to be written by the received data format conversion means and prevents data from being read out by the received data format conversion means.

The received data format conversion means is allowed only to read out data with an external format from the received data storage means, and only to write data with the internal format to the received process data storage means.

This makes data flow by the received data format conversion means one way flow from the network side to the host computer side. Then, the data flow from the host computer side to the network side is prevented, and data on the host computer side is protected.

### Construction 4

A network security system according to any one of constructions 1 to 3, wherein the data with the internal format are additionally stored at predetermined times into the database of the host computer from the received-processing data storage means.

In case the received process data storage means is arranged with apart from the host computer, data corresponding to the database of the host computer side arc transferred from the received process data storage means. Data can be transferred with predetermined timing, independent from action of the received data format conversion means. The timing of updating the database on the host computer side is optional.

### Construction 5

A network security system according to construction 4, wherein the conversion process from data with an external format to data with the internal format by the received data format conversion means and the additional storage process of the data with an internal format to the database of the host computer are respectively executed in a composite manner, with an independent timing.

Writing the received data in the received data storage means by the server is usually done with each piece of data. But the received data format conversion means executes the conversion process compositely. What is meant by composite execution is that processing occurs not of piece of data, but as a composite numerical number of data, such as occurs in a batch process. What is meant by execution with independent timing is that the activation control of each process is independent. There is no problem, of course, if controlling the activation timing is intended, for instance, in a manner in which the additional storage process initiates to the database of the host computer side automatically when the conversion process of the received data format conversion means is terminated.

### Construction 6

A network security system according to any one of constructions 1 to 3, wherein the received data format conversion means converts data with an external format to data with a database format.

Only the essential conversion process is executed to obtain data received from the network in the database processing with the host computer. Therefore, obtaining fraudulent data in the host computer side can be prevented.

### Construction 7

A network security system according to any one of constructions 1 to 3, wherein the server sends data with a mail format to the received data storage means and writes data with an external format.

The way that the server sends data with mail format to the received data storage means secures one-way flow of data to the received data storage means from the server more than the way that the server writes data with an external format by accessing the storage region of a storage device.

### Construction 8

A network security system according to any one of constructions 1 to 3, wherein the network is the Internet. The Internet requires much higher security among intranets. That is why this system is adopted.

### Construction 9

A network security system comprising a host computer to execute a predetermined process by using data with an internal format, a transmit process data format conversion means to storage data sent to the network, a transmit data format conversion means to convert data with an internal format stored in the transmit process data storage means and to store them in a transmit data storage means, and a server to send data with an external format stored in the transmit data storage means to the network.

A server is connected to the network. Data with an external format is sent to other terminal devices through the network. The ways of data with an external format and its data format type, data with the internal format and its data format type, and conversion of the data format type are the same as in the case of received data. The received data format conversion means reads data with the internal format from the transmit process data storage means and converts them to data with an external format in a fixed procedure, and then, writes them to the transmit data storage means.

The host computer writes data with the internal format to be sent to the transmit process data storage means with selective timing. Data with an external format sent from the server through the network is written by the transmit data format conversion means in the transmit data storage means. The server does not directly access to the transmit process data storage means. That is why accidentally sending out data to be protected on the host computer side can be prevented.

### Construction 10

A network security system according to construction 9, wherein the transmit process data storage means allows data with an internal format to be written by the host computer and prevents data from being read out by the host computer, and the transmit data storage means allows data with an external format which the server sends to be read out and prevents data from being written by the server.

The reason the transmit data storage means prevents data from being read out by the host computer is to prevent fraudulent data from invading from the network side. The reason writing data into the transmit data storage means by the host computer is prevented is to prevent fraudulent data from invading from the network side. This secures only the data flow from the host computer to the network, and the internal system including the host computer is protected. All data are prevented from being written or to be read out. All formats of data are included regardless of the type.

### Construction 11

A network security system according to construction 9 or 10, wherein the transmit process data storage means allows data with an internal format to be read out by the transmit data format conversion means and prevents data from being written by the transmit data format conversion means, and the transmit data storage means allows data with an external format to be written and prevents data from being read out by the transmit data format conversion means.

The transmit data format conversion means is allowed only to read out data with internal format from the transmit data storage means, and only to write data with an external format to the transmit process data storage means. This manner makes the data flow by the transmit data format conversion means to be one way flow from the host computer side to the network side. Then, data flow from the network side to the host computer side is prevented, and data in the host computer side is protected.

### Construction 12

A network security system according to any one of constructions 9 to 11, wherein the conversion process from data with the internal format to data with an external format by the transmit data format conversion means is executed with independent timing from the storage process of data with the internal format to the transmit process data storage means by the host computer.

The transmit data format conversion means can execute the conversion process with selective timing since the transmit process data storage means is arranged. Also, the host computer can write data with an internal format for sending with selective timing into the transmit process data storage means. The format of the internal data for sending is optional, and is not limited to database formats.

### Construction 13

A network security system according to any one of constructions 9 to 11, wherein the server receives data with mail format from the transmit data storage means and sends them to the network.

The way that the server sends data with mail format to the transmit data storage means secures one way flow of data to the transmit data storage means from the server more than the way that the server writes data with an external format with accessing the storage region of a storage device.

### Construction 14

A network security system according to any one of constructions 9 to 11, wherein the network is the Internet.

The Internet requires much higher security compared with an ordinary intranet. That is the reason for adopting this system.

### Construction 15

A network security system comprising a received data storage means to storage data with an external format which a server received through the network, a received data format conversion means to convert data with an external format stored in the received data storage means to data with an internal format and to store them in the received process data storage means, a host computer to execute a predetermined process by using data with the internal format stored in the received process data storage means, a transmit process data storage means to store data with the internal format sent to the network, a transmit data format conversion means to convert data with the internal format stored to the transmit process data storage means to data with an external format, and a server to send data with an external format stored in the transmit data storage means to the network.

The function of data received in construction 1 and the function of data sending in construction 9 are both arranged in the system stated here.

### Construction 16

A network security system according to construction 15, wherein the conversion process of from data with an external format to data with the internal format by the received data format conversion means, the additional storage process of the data with the internal format to the database of the host computer side, the conversion process from data with the internal format to data with an external format by the transmit data format conversion means, and the storage process of data with the internal format to the transmit process data storage means by the host computer each are executed with independent timing.

As a barrier to one way flow is arranged in this manner, and data transfer is executed in order with each independent timing, protection of the host computer side from the network is reinforced. This has the effect that there is no way to send a fixed command from the network side using the data receiving function in construction 1 and to read out some data from the host computer side using the data sending function.

### Construction 17

A network security system comprising a server connected to the network and a mail transfer section connected to a host computer side, wherein a mail client and a mail server are arranged in the server, a mail receiving section to receive mail through communication line from the mail client and a mail sending section to send mail through the communication line to the mail server are arranged in the mail transfer section, and the host computer receives a data transfer from the server through the mail receiving section of the mail transfer section and transfer data to the server through the mail sending section of the mail transfer section.

Data transfer between the server and mail transfer section are implemented only with a fixed mail format. The host computer gives and takes data with the server only through the mail transfer section. That is why there is no way for fraudulent commands or fraudulent programs to be transferred between the server and the mail transfer section.

### Construction 18

A network security system according to construction 17, wherein the communication line is a communication line dedicated to mail.

Connection between the server and the mail transfer section with a communication line which is dedicated to mail and does not have a path for other data invading can maintain security with more certainty.

### Construction 19

A network security system comprising a mail server arranged on the network side and a mail transfer section arranged on the host computer side, wherein a mail receiving section to receive mail from the mail server through a mail dedicated line and a mail sending section to send mail to the mail server through a mail dedicated line are arranged, and the host computer receives data transfer from the mail server through the mail receiving section of the mail transfer section and transfers data to the mail server through the mail sending section of the mail transfer section.

The mail server is arranged on the network side, and sends and receives mail through a dedicated line between the mail server and the mail transfer section of the host computer side. A dedicated line is optional if a line is a communication line, which would be only used for communication between the mail server and the host computer side. The host computer is protected from the network side, because the dedicated line is used for data transfer between the network and the host computer only by a fixed means.

### BRIEF DESCRIPTION OF DRAWINGS

FIG. 1 is a block diagram showing the example of the system related to the present invention.

FIG. 2 is an explanation drawing to explain the actions of the process that data the server received are converted and stored in the received process data means.

FIG. 3 is a flow chart of the actions with the server and the received process data storage.

FIG. 4 is a block-diagram indicating the example using the present invention to the system for the sending process.

FIG. 5 is a block diagram of the system further reinforcing the security function.

FIG. 6 is another system of block diagram reinforcing the security function by use of mail sending.

### EMBODIMENT

As follows, embodiment related to the present invention is explained in use of examples.

Receiving Process

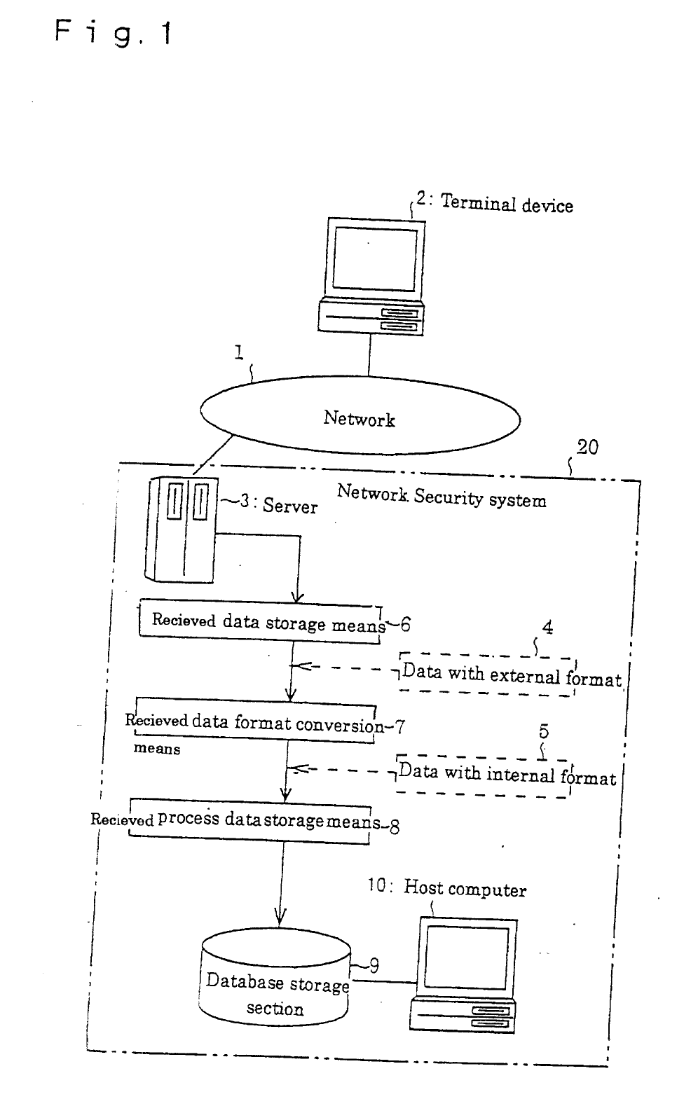

FIG. 1 is a block diagram showing an example of the system of the present invention.

As shown in the figure, the various terminal devices 2 which users utilize are connected to the terminal 2. A system for providing information for purchasing goods, for instance, is connected to the network 1. This system constitutes the network security system 20 to reinforce the protection function by the present invention. The network security system 20 comprises a server 3, received data storage means 6, received data format conversion means 7, received process data storage means 8 and a host computer 10.

The server 3 is connected to the network 1. Inside of the server 3, a storage device, not shown, to store the information to provide users is installed. This network is preferably applied to the Internet, but can be applied to all other networks other than internet, such as a telephone network specifying users, and intranet.

When an order is place by a user, the server 3 receives the order information through the network 1. The host computer 10 is placed to process the order information and to arrange and administrate goods. The received data storage means 6, the received data format conversion means 7 and the received process data storage means 8 transfer the order information received by the server to the host computer 10. The host computer 10 stores the order information in the database storage section 9 from the received process data storage means 8 and administrates the orders.

The received data storage means 6 comprises a storage device for storing the data with an external format 4 which the server 3 receives through the network. The data with an external format 4 is what is received from other terminal devices through the network, whose format is an optional format such as an e-mail format and a data file format. Also data with a text type of format, or data with a binary type of format is applicable. The received data format conversion means 7 has the function of reading data with an external format 4 from the received data storage means 6, to convert it to the data with the internal format 5 in a fixed procedure, and then to write it in the received process data storage means 8. The received data format conversion means 7 should be preferably implemented by computer programming, but can be implemented by hardware. Conversion of data format can be arranged optionally including extraction, sorting, partial delete, data addition, and the like. The received data format conversion means 7 has the effect of filtering fraudulent data contained in the received data as the received data format conversion means 7 does not transfer data simply.

The format of the data with the internal format 5 is optional as well, but the data has a fixed format pre-regulated on the host computer side. In this example, data with a CSV format is applied, because with the CSV format it is easy to update the database stored in the database storage section 9. Data with the CSV format are data with a text type format. The received data format conversion means 7 analyses data with an external format the server 3 received, extracts the necessary data items and generates data with the internal format. The received process data storage means 8 is a storage device to store fixed amounts of data with the internal format 5 and hold them until the data with the internal format 5 is written in the database storage section 9.

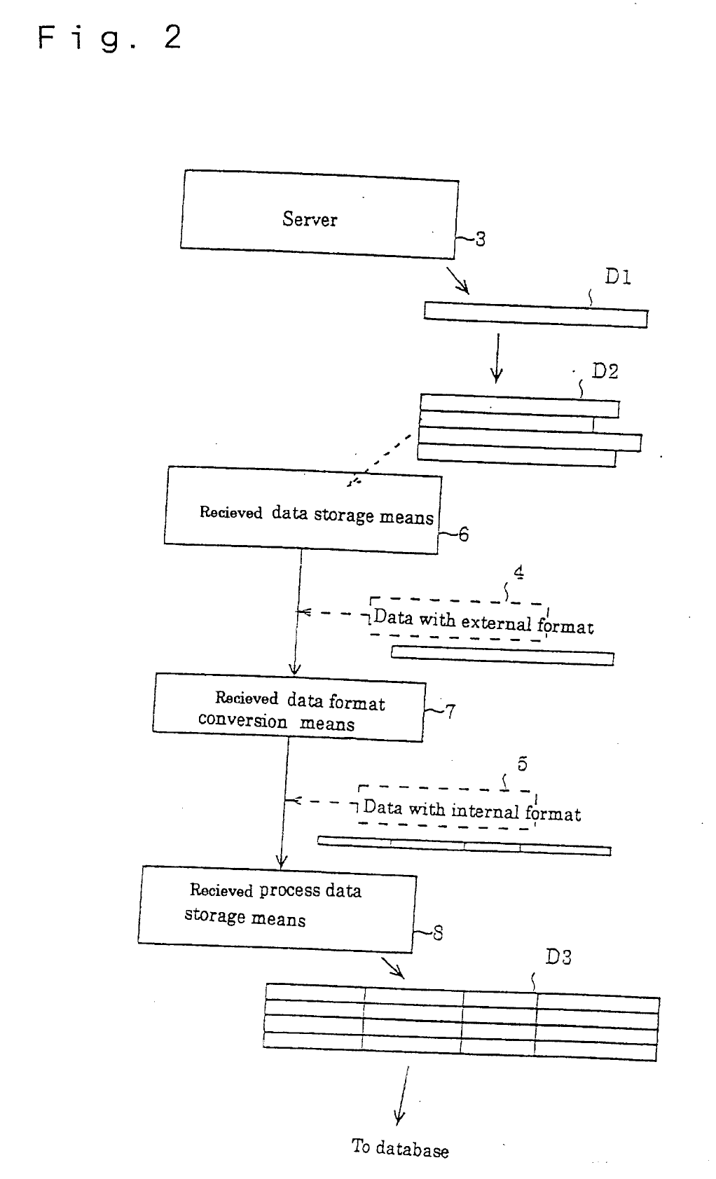

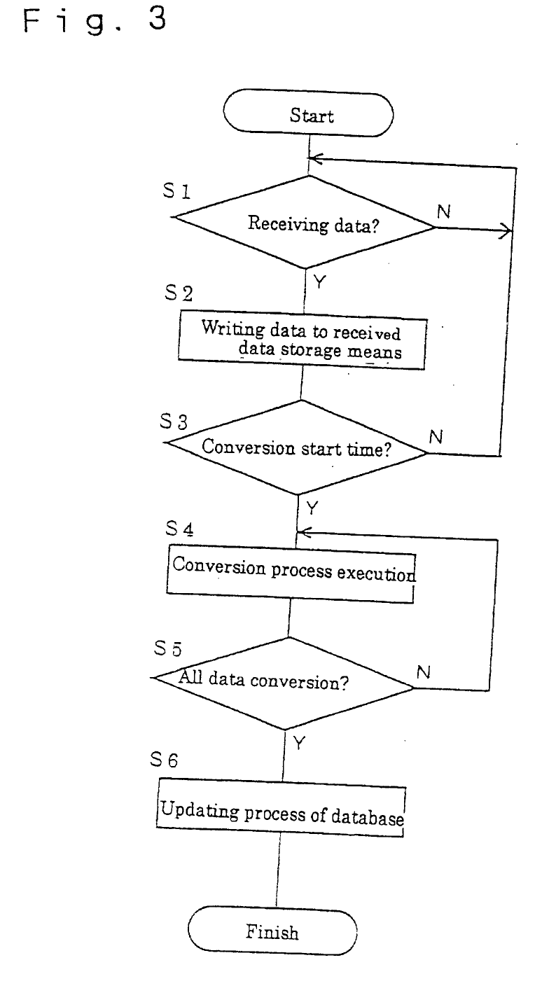

FIG. 2 is an explanatory drawing to explain the action in which data the server received is converted into the data being stored in the received process data storage means. FIG. 3 is a flow chart of the actions with the server and the received process data storage means, and the like.

The actions are explained hereafter, with reference to the drawings. First, the server writes data D1 received from the network 1 in order in the received data storage means 6(FIG. 3 step S1, step S2). Data D2 accumulated in the received data storage means 6 is read out by the received data format conversion means 7 at fixed intervals, and undergoes the conversion process to the data with the internal format 5 from the data with an external format 4(FIG. 3 step S3, step S4).

For instance, in case of administration of ordering data, this conversion process is set up to be executed once during night each day, twice a day, or every other hour. Therefore, the received data format conversion means 7 should monitor the system timer and commence the action when the time for conversion starting is up.

In the case of administration of ordering, data with mail format containing data on user codes, ordered goods codes, quantity to be ordered, and the like are stored in the received data storage means. If data indicating the location of the user code, for instance, is contained in the data with an external format, the data can be detected and cut off. And only the portion of the user code can be extracted. At this time, as the other parts than the user code and necessary data are cut off and thrown away automatically, obtaining fraudulent data can be prevented. When obtaining data, if a format with the data is inspected, obtaining camouflaged data can be prevented. The received data format conversion means 7 extracts the necessary data items in this manner, and generates a text format of data separated, for instance, by commas. This data is written in the received process data storage means 8.

When the conversion process of all data D2 stored in the received data storage means is finished, the program goes to step S6 from step S5 in FIG. 3 and the updating process of the database is executed. Data D3 stored in the received process data storage means 8 are written in the database as they are. In case the data D3 are data with CSV format stated above, they can be taken into the database as they are and used for organizing received orders.

In the example above, after the conversion process of data with an external format 4 to data with the internal format 4 by the received data format conversion means 7, the storage process of this data with the internal format for addition to the database on the host computer side are executed. However, these processes should be executed independently for the convenience of system operation. The conversion process by the received data format conversion means 7 is preferably executed when data with an external format is accumulated in some amount or when access to the server is not so busy.

The server usually writes the received data in the received data storage means with one piece of data. What is meant by composite execution is to be processed not for each piece of data but a composite of numerical number of data, as with a batch process. What is meant by execution with independent timing is the independent activation control of each process. There is no problem, of course, if controlling the activation timing is intended, for instance, in a manner in which an additional storage process initiates to the database of the host computer side automatically when the conversion process of the received data format conversion means is terminated.

The received data format conversion means 7 is not just an interface between the server and the host computer. It has the function of a filter for one-way flow to extract and fabricate only the necessary data from data with an external format which might contain fraudulent data, and to convert them to data with pre-established, safe, internal format. Data with an external format the sever 3 received through the network 1 shown in FIG. 1 is written into the received data storage means 6. The host computer 10 does not make direct access to this received data storage means 6. That is why the host computer 10 can be prevented from obtaining fraudulent data from the network 1.

In FIG. 1, the received data storage means 6 can be a storage device set up,, to be independent from the server 3, or can be part of the storage device arranged inside of the server or the host computer 10. The received process data format conversion means 8 as well can be a storage device set up independently from the server or the host computer 10, or can be part of the storage device arranged in the inside of the host computer. The received data format conversion means 7 can be a computer program working on the server 3 or a computer program working on the host computer 10.

Furthermore, the received data storage means 6 could allow data with an external format the server 3 received to be written, but should prevent all data from being read out by the server 3. This can be implemented, for instance, by a well known function of the operation system. Or as explained later, the server 3 should transfer data with a mail format to the received data storage means 6. This can prevent data in the received data storage means 7 from being read out from the network side. The received process data storage means 8 could allow data with the internal format to being read out by the host computer 10, but should prevent all data from being written by the host computer 10.

Working of the received data format conversion means 7 can be limited as well.

Namely the received data storage means 6 allows data with an external format to be read out by the received data format conversion means 7, while preventing all data from being written by the received data format conversion means 7. The received process data storage 8 allows data with the internal format to be written by the received data format conversion means 7, while preventing all data from being read out by the received data format conversion means 7. As stated above, it is feasible to effectively protect the internal system from hackers by arranging several barriers with one way flow.

Sending Process

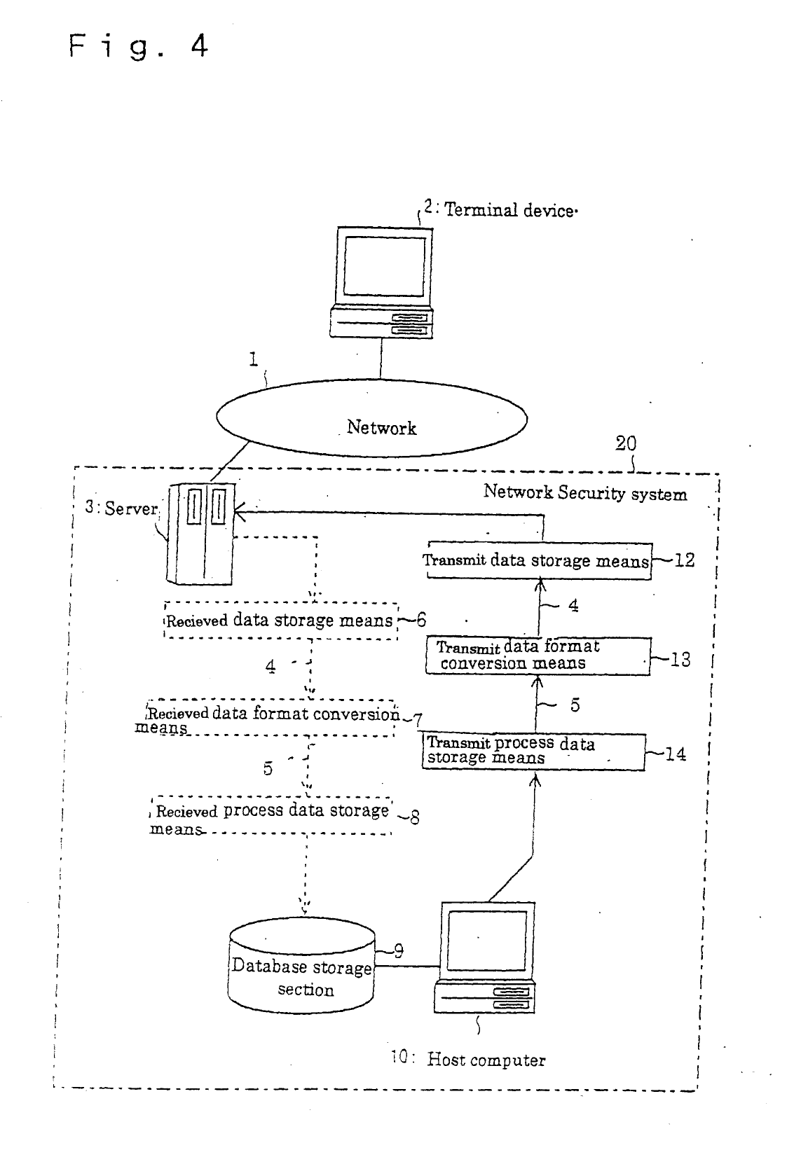

FIG. 4 is a block diagram showing the example of a system for sending process. The system shown in FIG. 1 takes data received through the network into the database processed by the host computer safely. This can apply to the case of sending data from a host computer to a network. FIG. 4 is one such example. The blocks the system in FIG. 1 comprises are denoted with a dashed line for purposes of distinction.

In the system in FIG. 4, the host computer 10 has the received data storage means 12, the received data format conversion means 13 and the transmit process data storage means 14. The rest is the same as the system in FIG. 1. The host computer 10 executes ordering administration and the like in the use of the database storage section 9. The received process data storage means 14 is a storage device to store data with the internal format which the host computer generates and sent to the network The transmit data format conversion means 13 has a function to convert data with the internal format stored in the transmit process data storage means 14 to data with an external format and to create the data stored in the transmit data storage means 12. This, as well as the example in FIG. 1, comprises the computer program and the like. The server 3 has a function to send data with an external format stored in the transmit data storage means to the network. The content and format of data with an external format and internal format is the same as the example in FIG. 1.

In this system, if the host computer 10 has data to be sent through the network, the host computer converts this to the data with the internal format with selective timing and makes it stored in the received process data storage means 14. The transmit data format conversion means 13 is, for instance, activated in each case by the host computer, and reads out data with the internal format from the transmit process data storage means 14 and converts it to data with an external format. And then, it writes it to the transmit data storage means 12. This action is different from the case of data received in FIG. 1. As the transmit data format conversion means 13 can acquire information on emergency of sending data from the host computer, the timing of sending data should be classified.

After data are written in the transmit data storage means 12, the server should conduct a sending process to the network with emergency of data sending considered, as well. In this example also, the transmit process data storage means 14 allows data with the internal format to be written by the host computer, and should prevent data from being read out by the host computer. The transmit data storage means 12 preferably allows data with an external format sent by the server to be read out, and prevents data from being written by the server 3.

Furthermore, the transmit process data storage means 14 preferably allows data with the internal format to be read out by the transmit data format conversion means 13, while should prevent data from being written by the transmit data format conversion means 13. The transmit data storage means 12 preferably allows data with an external format the server sends to be written by the transmit data format conversion means 13, while preventing data from being read out by the received data format conversion means 13. As stated above, it is feasible to prevent hackers from stealing data by arranging several barriers with one way flow to the network.

The conversion process of data with the internal format to data with an external format by the received data format conversion means 13 can be executed with independent timing from the storage process of data with the internal format to the transmit process data storage means 14 by the host computer 10. The system combining the system to receive data indicated in FIG. 1 and the system to send data indicated in FIG. 4 can present extremely high security as far as received and transmit data is concerned. It is preferable that the conversion process by the received data format conversion means 7 shown in FIG. 4, the additional storage process of data with the internal format to the database of the host computer 10 side, the storage process of data to the received process data storage means 14 by the host computer 10 and the conversion process by the received data format conversion means 13 each are preferably executed with independent timing.

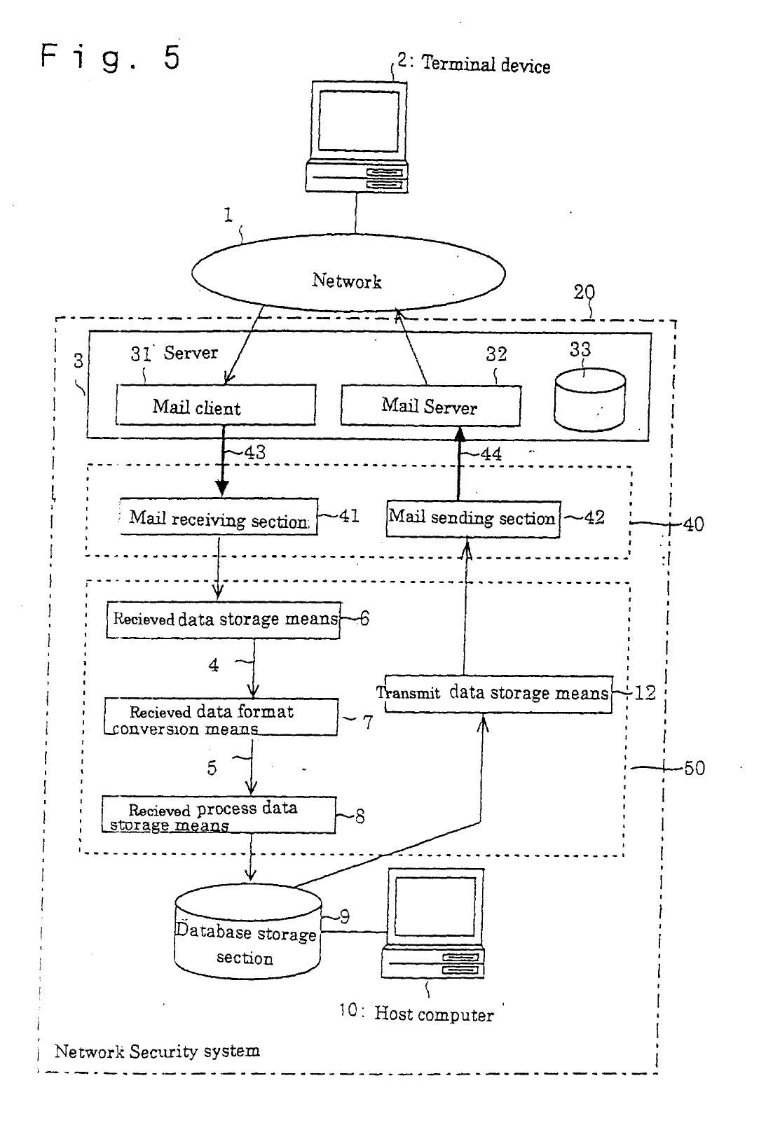

FIG. 5 is a block diagram to more greatly reinforce the security function of the system.

Usually a specified region in the storage device of a computer can be controlled with only reading out, and the rest of region in the storage device can be controlled with both reading out and writing being prevented. However, it is not easy to prevent hackers from invading the system completely by a fraudulent means as this kind of control is accomplished by software. For instance, if each function block shown in the system of FIG. 1 is brought into practice using a single computer, it would be the same as if the received data storage means 6, the received process data storage means 8, the transmit data storage means 12 and the transmit process data storage means 14 were all located on one memory. The server 3 and the host computer 10 could be connected directly by LAN (Local Area Network) and share a storage device. In such a case, it would not be easy to prevent fraudulent access completely to the received process data storage means 8 and the transmit process data storage means 14, which should be protected on the host computer side.

Therefore, in this example, a mail system which can transfer only with a fixed format, is used to connect between the server and the host computer.

The server in the Figure has the mail client 31, the storage device 33 and the mail server 32. Also, the mail transfer section 40 has the mail receiving section 41 and the mail sending section 42. Further the data conversion section 50 has the received data storage means 6, the received data format conversion means 7, the received process data storage means 8 and the transmit data storage means 12. In the example, the function of the mail transfer section 40 stated above controls a way to transfer data in the sever 3 and the data transfer of the host computer side to reinforce the security of the host computer side. If the data transfer section 50 is arranged with the mail transfer section 40, it could secure higher security of the system.

The mail receiving section 41 of the mail transfer section 40 is a device to have a mail receiving function, and the mail sending section 42 is a device to have a mail sending function. These mail transfer section 40 and the server 3 are preferably connected only with cables for mail receiving and sending 43, 44. Data transfer between the server 3 and the mail transfer section 40 are not executed without a fixed mail format under this configuration. For instance, if data format transferred with this mail is limited with a text format of data, it would not occur that fraudulent commands and program are transferred between the server 3 and the mail transfer section 40.

The system described above works as follows.

In the storage device 33 of the server 3, for instance, web page data such as a home page to sell goods through the network 1 such as the internet are stored. The mail client 31 sends data to place order for goods to the mail receiving section 41 of the mail transfer section 40 with a mail format, when the mail client receives it from users with the terminal device 2 through the network. The mail receiving section 41 has the received mail to be stored in the received data storage means 6.

As has been explained, in the following process, the data is taken in the database 9 after the conversion of data format. The data conversion section 50 can comprise a means to convert the data format to the database format and write database 9 directly.

On the other hand, in case an order being placed, the host computer generates a comment telling us ‘Receiving an order” and delivery information including a shipping date. This comment and information are stored in the transmit data storage means 12. The mail sending section 42 sends this comment an information to the mail server 32 after this comment and information are converted to data with mail format. The mail server 32 sends the data to the network.

In other words, the mail client 31 sends data with the mail format to the mail receiving section 41, but does not have a function to receive mails. The mail server 32 receives mails from the mail sending section 42 but does not have a function to send mails. A dedicated communication line for transferring should be used to make connection between the server 3 and the mail transfer section 40. By this way, the server 3 and the mail transfer section 40 can be constituted separately in hardware's point of view. The communication line is preferably one which does not have a invading route of other data to enhance the security more. As only data with mail format, not data with the other format is transferred, there is no way that fraudulent commands or data are taken in the host computer and the like. Therefore, this communication line is one-way data transfer path with reliability. This will provide the function of high protection to the system requiring high security.

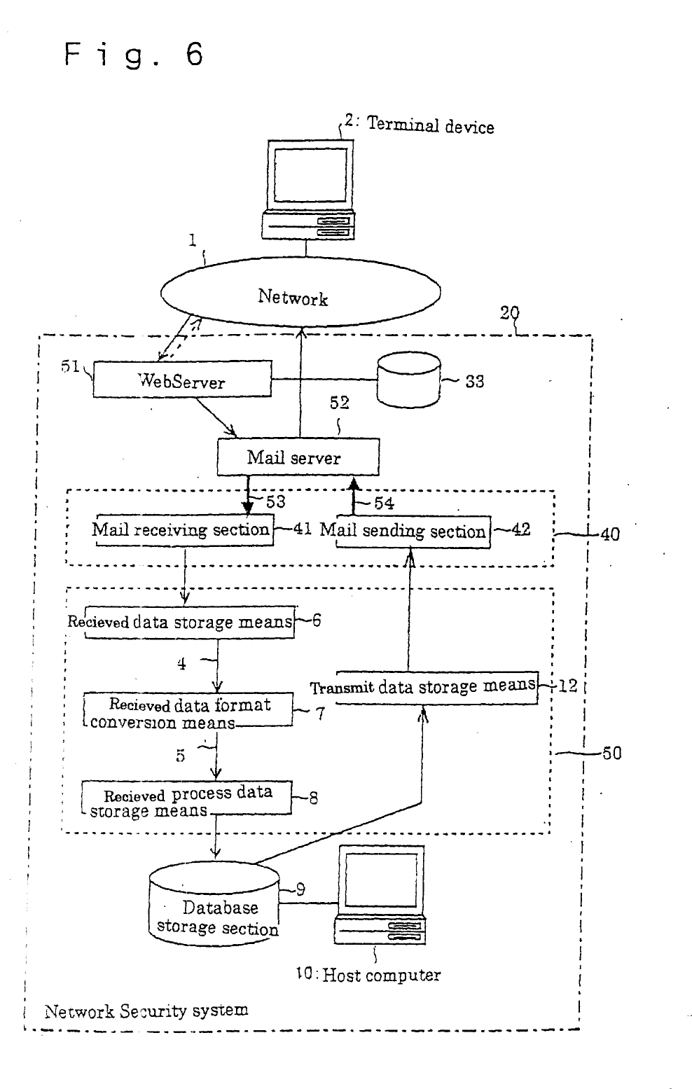

FIG. 6 is a block diagram with another system to reinforce the security by use of mail transfer. In the example of this figure, web server 51 of the system 20 is connected to the network 1 and makes communication with the network 1. This web server 51 is connected to the mail server 52. The mail server 52 is connected to the mail receiving section 41 of the mail transfer section 40 through the mail dedicated line 53. And the mail server 52 is connected to the mail sending section 42 of the mail transfer section 40 through the mail dedicated line 54. The portion below the mail transfer section 40 to the host computer is the same as FIG. 5. This system is ensured to have enough high security whether the mail transfer section 40 is connected to the host computer directly or the mail transfer section 40 is a part of the host computer 10.

The mail-dedicated lines 53, 54 above, are used only for transfer of mail between the mail server 52 and the mail transfer section 40. These lines cannot transfer data with any format but a specified one, as these lines are used only for mail transfer. Therefore, illegal invasion from the network side to the host computer side can be assuredly prevented. It will not happen that data are sent out from the host computer to the network carelessly. The dedicated lines 53, 54, can be made up of a separate cable for upward and downward as in the figure or can be made of one cable capable of transferring mail in both directions. Also in this example, for convenience of the explanation above, arrows are indicated for data to be transferred only in one direction from the network 1 to the web server 51. But communication between the network 1 and the web server 51 can be made in both directions.

In the system stated above, when data to place orders for goods from the terminal 2 is sent to the network 1, web server 51 receives it. The web server 51 sends the received data to the mail server 52. The mail server 52 sends the data to the mail receiving section 41 through the dedicated line 53 with mail format. On the other hand, mails sent from the host computer 10 are transferred to the mail server 52 through the dedicated line 54 from the mail sending section 42. The mail server 52 sends the mail to the terminal device 2 through the network 1 in use of the own function of mail receiving. The rest of the parts are the same as has been already explained, and a superfluous explanation is omitted. In this manner, the mail transfer by use of the dedicated lines 53, 54 can provide protection and reinforcement of the internal system from the network.

Each function block indicated in each figure can comprise each separate program module, or can be composed of an integrated program module. The whole or part of these function blocks can comprise a hard ware by a logical circuit. Each program module can be operated by installation into an existing application program, or can be operated as an independent program.

1. A network security system comprising a server connected to a network, a received data storage means to store data with an external format which a server received through the network, a received data format conversion means to convert data with an external format stored in the received data storage means to data with an internal format, and to store it in a received-process data storage means and a host computer to execute a predetermined process utilizing data with the internal format stored in the received-process data storage means.

2. The network security system according to claim 1, wherein the received data storage means allows data with an external format which the server received to be written, and prevents data by the server from being read out, a received process data storage means allows data with the internal format to be read out by the host computer and prevents data from being written by the host computer.

3. The network security system according to claim 1 or 2, wherein the received data storage means allows data with an external format to be read out by the received data format conversion means and prevents data from being written by the received data format conversion means, and the received process data storage means allows data with the internal format to be written by the received data format conversion means and prevents data from being read out by the received data format conversion means.

4. The network security system according to any one of claims 1 to 3, wherein the data with the internal format are stored additionally with a predetermined time of period into the database of the host computer from the received-processing data storage means.

5. The network security system according to claim 4, wherein the conversion process from data with an external format to data with the internal format by the received data format conversion means and additional storage process of the data with the internal format to the database of the host computer are executed in a lump sum maimer with an independent timing respectively.

6. The network security system according to any one of claims 1 to 3, wherein the received data format conversion means converts data with an external format to data with database format.

7. The network security system according to any one of claims 1 to 3, wherein the server sends data with mail format to the received data storage means and writes data with an external format.

8. The network security system according to any one of claims 1 to 3, wherein the network is the Internet.

9. A network security system comprising a host computer to execute a predetermined process by use of data with an internal format, a transmit process data format conversion means to storage data sent to the network, a transmit data format conversion means to convert data with the internal format stored in the transmit process data storage means and to store it in the transmit data storage means, and a server to send data with an external format stored in the transmit data storage means to the network.

10. The network security system according to claim 9, wherein the sending process data storage means allows data with the internal format to be written by the host computer and prevents data from being read out by the host computer, and the transmit data storage means allows data with an external format which the server sends to be read out and prevents data from being written by the server.

11. The network security system according to claim 9 or 10, wherein the transmit process data storage means allows data with the internal format to be read out by the transmit data format conversion means and prevents data from being written by the transmit data format conversion means, and the transmit data storage means allows data with an external format to be written and prevents data from being read out by the transmit data format conversion means.

12. The network security system according to any one of claims 9 to 1 1, wherein the conversion process from data with the internal format to data with an external format by the transmit data format conversion means is executed on an independent timing from the storage process of data with the internal format to the transmit process data storage means by the host computer.

13. The network security system according to any one of claims 9 to 11, wherein the server receives data with mail format from the transmit data storage means and sends it to the network.

14. The network security system according to any one of claims 9 to 11, wherein the network is the Internet.

15. A network security system comprising a received data storage means to storage data with an external format which a server received through the network, a received data format conversion means to convert data with an external format stored in the received data storage means to data with an internal format and to store it in the received process data storage means, a host computer to execute a predetermined process by use of data with the internal format stored in the received process data storage means, a transmit process data storage means to store data with the internal format sent to the network, a transmit data format conversion means to convert data with the internal format stored in the transmit process data storage means to data with an external format, and a server to send data with an external format stored in the transmit data storage means to the network.

16. The network security system according to claim 15, wherein the conversion process of from data with an external format to data with the internal format by the received data format conversion means, the additional storage process of the data with the internal format to the database of the host computer side, the conversion process from data with the internal format to data with an external format by the transmit data format conversion means, and the storage process of data with the internal format to the transmit process data storage means by the host computer each are executed with independent timing.

17. A network security system comprising a server connected to the network and a mail transfer section connected to a host computer side, wherein a mail client and a mail server are arranged in the server, a mail receiving section to receive mails through communication line from the mail client and a mail sending section to send mails through communication line to the mail server are arranged in the mail transfer section and the host computer receives a data transfer from the server through the mail receiving section of the mail transfer section and transfer data to the server through the mail sending section of the mail transfer section.

18. The network security system according to claim 17, wherein the communication line is a communication line dedicated to a mail.

19. A network security system comprising a mail server arranged on the network side and a mail transfer section arranged on the host computer side, wherein a mail receiving section to receive mails from the mail server through a mail dedicated line and a mail sending section to send mails to the mail server through a mail dedicated line are arranged, and the host computer receives data transfer from the mail server through the mail receiving section of the mail transfer section and transfer data to the mail server through the mail sending section of the mail transfer section.
